(19) United States
(12) Patent Application Publication
(10) Pub. No.: US 2022/0044648 A1
(43) Pub. Date: Feb. 10, 2022

(54) ELECTRONIC APPARATUS AND METHOD OF CONTROLLING THE SAME

(71) Applicant: SAMSUNG ELECTRONICS CO., LTD., Suwon-si (KR)

(72) Inventors: Jaesung PARK, Suwon-si (KR); Jiman KIM, Suwon-si (KR); Dongbae LEE, Suwon-si (KR)

(73) Assignee: SAMSUNG ELECTRONICS CO., LTD., Suwon-si (KR)

(21) Appl. No.: 17/511,118

(22) Filed: Oct. 26, 2021

Related U.S. Application Data
(63) Continuation of application No. PCT/KR2021/008985, filed on Jul. 13, 2021.

(30) Foreign Application Priority Data
Aug. 5, 2020 (KR) 10-2020-0097789

(51) Int. Cl. G09G 3/36

(52) U.S. Cl. CPC G09G 3/3648; G09G 2320/046; G09G 2320/0257

(57) ABSTRACT

An electronic apparatus and a method of controlling the same are provided. The electronic apparatus includes: a display; and a processor configured to: obtain usage data based on use of the electronic apparatus; identify image-quality degradation of the display based on the usage data and reference data obtained based on a relationship between a use pattern of the electronic apparatus and the image-quality degradation of the display; and control the display based on the identified image-quality degradation of the display.

### CROSS-REFERENCE TO RELATED APPLICATION(S)

This application is a by-pass continuation application of International PCT Application No. PCT/KR2021/008985 filed Jul. 13, 2021, which is based on and claims priority to Korean Patent Application No. 10-2020-0097789 filed Aug. 5, 2020 in the Korean Intellectual Property Office, the disclosures of which are incorporated by reference herein in their entirety.

### BACKGROUND

### 1. Field

The disclosure relates to an electronic apparatus in which an image displayed on a display is prevented from degradation, and a method of controlling the same.

### 2. Description of Related Art

In an electronic apparatus with a display (or a display panel), the performance of the display starts deteriorating from the moment when a user purchases and uses the electronic apparatus. Therefore, a non-luminescent display device (e.g., a liquid crystal display (LCD)) and a luminescent display device (e.g., an organic light-emitting diode (OLED)), and products using them may experience problems related to image persistence due to image-quality degradation (e.g., image sticking, burn-in, retention, etc.).

The image-quality degradation may vary depending not only on materials, but also on viewing conditions or the use pattern of a user, for example, thin film transistor (TFT) structures and materials in a non-luminescent display, pixel intensity, code value, displaying duration or the like in a luminescent display. Like this, there are various factors causing the image-quality degradation. However, without analyzing such factors, after the image persistence or image retention has occurred due to the image-quality degradation, measures, such as a pixel shift, a decrease in the whole brightness of the display, etc., have been proposed to prevent the image-quality degradation.

When a method of compensating for the image persistence is provided interworking with an on-screen display (OSD), the OSD may, for example, notify a user to take action in protecting the display. However, this method is inconvenient for the user because it does not automatically prevent the image persistence, but only notifies the user to take further actions to cease the image persistence.

### SUMMARY

Provided are an electronic apparatus in which an image displayed on a display is more effectively prevented from degradation, and a method of controlling the same.

In accordance with an aspect of the disclosure, there is provided an electronic apparatus including: a display and a processor. The processor is configured to: obtain usage data based on use of the electronic apparatus; identify image-quality degradation of the display based on the usage data and reference data obtained based on a relationship between a use pattern of the electronic apparatus and the image-quality degradation of the display; and control the display based on the identified image-quality degradation of the display.

The processor may be further configured to: identify the image-quality degradation of the display based on a relationship between characteristic data of the display and the image-quality degradation of the display.

The processor may be further configured to: vectorize the usage data, and identify the image-quality degradation of the display by compressing a dimension of the vectorized usage data.

The processor may be further configured to identify the image-quality degradation of the display according to screen areas of the display.

The processor may be further configured to identify the image-quality degradation of the display by expanding the compressed dimension of the vectorized usage data to correspond to screen areas of the display, based on the characteristic data of the display.

The processor may be further configured to periodically identify the image-quality degradation of the display.

The reference data may include a model learned to identify the image-quality degradation of the display based on the use of the electronic apparatus.

The electronic apparatus may further include an interface, and the processor may be further configured to: transmit the obtained usage data to a server through the interface, and receive a result of identifying the image-quality degradation of the display from the server.

The processor may be further configured to display a graphic user interface (GUI) including the identification result on the display.

The processor may be further configured to receive a user input indicating whether to control the display based on the identified image-quality degradation of the display, through the GUI.

In accordance with an aspect of the disclosure, there is provided a method of controlling an electronic apparatus, including: obtaining usage data based on use of the electronic apparatus; identifying image-quality degradation of a display based on the usage data and reference data obtained based on a relationship between a use pattern of the electronic apparatus and the image-quality degradation of the display; and control the display based on the identified image-quality degradation of the display.

The identifying the image-quality degradation of the display may further include: identifying the image-quality degradation of the display based on a relationship between characteristic data of the display and the image-quality degradation of the display.

The identifying the image-quality degradation of the display may further include: vectorizing the usage data; and identifying the image-quality degradation of the display by compressing a dimension of the vectorized usage data.

The identifying the image-quality degradation of the display may further include: identifying the image-quality degradation of the display according to screen areas of the display.

The identifying the image-quality degradation of the display may further include: identifying the image-quality degradation of the display by expanding the compressed dimension of the vectorized usage data to correspond to screen areas of the display, based on the characteristic data of the display.

The identifying the image-quality degradation of the display may include: periodically identifying the image-quality degradation of the display.

The method may further include: transmitting the obtained usage data to a server through an interface of the electronic apparatus, and receiving a result of identifying the image-quality degradation of the display from the server.

The method may further include: displaying a graphic user interface (GUI) including the identification result on the display.

The method may further include receiving a user input indicating whether to control the display based on the identified image-quality degradation of the display, through the GUI.

In accordance with an aspect of the disclosure, there is provided a recording medium stored with a computer program including a code for performing a method of controlling an electronic apparatus, as a computer readable code. The method include: obtaining usage data based on use of the electronic apparatus; identifying image-quality degradation of a display based on the usage data and reference data obtained based on a relationship between a use pattern of the electronic apparatus and the image-quality degradation of the display; and control the display based on the identified image-quality degradation of the display.

### Advantageous Effects

According to an aspect of the disclosure, risk of image persistence is detected based on an artificial intelligence (AI) technique that reflects various factors affecting image-quality degradation of a display, thereby reducing costs and complexity, and flexibly and effectively coping with the image persistence.

Embodiments of disclosure may be economical and effective because risk of image persistence is previously detected based on a relationship between a user's pattern of using an electronic apparatus and image-quality degradation of a display.

Embodiments of the disclosure may effectively prevent image persistence by providing measures against the image persistence while informing a user of a result from identifying image-quality degradation, and may provide information about the risk of the image persistence as well directly reduce the risk of the image persistence by marking an area where the risk of the image persistence is occurs on a display.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an operation of an electronic apparatus according to an embodiment;

FIG. 2 is a block diagram of an electronic apparatus according to an embodiment;

FIG. 3 is an operation flowchart of an electronic apparatus according to an embodiment;

FIG. 4 illustrates usage data obtained according to an embodiment;

FIG. 5 illustrates an example of a convolutional neural network (CNN) structure used by an electronic apparatus according an embodiment;

FIG. 6 illustrates an operation of an electronic apparatus according to an embodiment;

FIG. 7 is an operation flowchart of an electronic apparatus according to an embodiment;

FIG. 8 illustrates an operation of an electronic apparatus according to an embodiment;

FIG. 9 illustrates an operation of an electronic apparatus according to an embodiment;

FIG. 10 illustrates an operation of an electronic apparatus according to an embodiment; and

FIG. 11 illustrates an operation of an electronic apparatus according to an embodiment.

### DETAILED DESCRIPTION

Below, embodiments of the disclosure will be described in detail with reference to the accompanying drawings. In the drawings, like numerals or symbols refer to like elements having substantially the same function, and the size of each element may be exaggerated for clarity and convenience of description. However, the technical concept of the disclosure and components and functions are not limited to those described in the following embodiments. In the following descriptions, detailed description of well-known technologies or components may be omitted if they unnecessarily obscure the gist of the disclosure.

Herein, terms ‘first’, ‘second’, etc. are only used to distinguish one element from another, and singular forms are intended to include plural forms unless otherwise mentioned contextually. Further, it will be understood that terms ‘comprise’, ‘include’, ‘have’, etc. do not preclude the presence or addition of one or more other features, numbers, steps, operation, elements, components or combination thereof. In addition, a ‘module’ or a ‘portion’ may perform at least one function or operation, be achieved by hardware, software or combination of hardware and software, and be integrated into at least one module. Herein, at least one among a plurality of elements refers to not only all the plurality of elements, but also both each one of the plurality of elements excluding the other elements and a combination thereof.

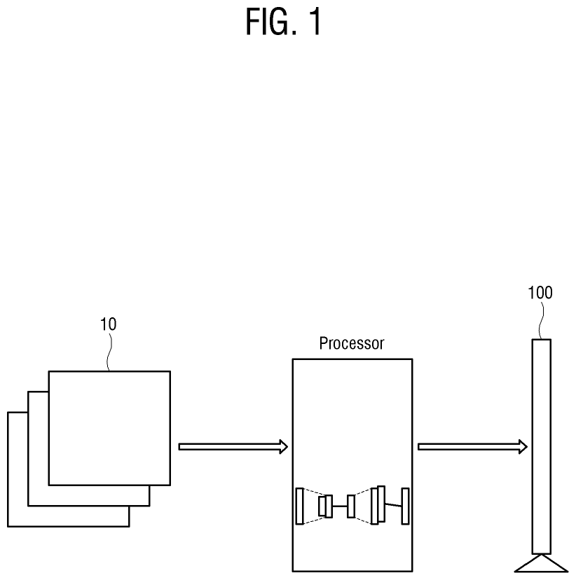

FIG. 1 illustrates an operation of an electronic apparatus according to an embodiment. Referring to FIG. 1, an electronic apparatus 100 may receive one or more contents 10. The electronic apparatus 100 according to an embodiment of the disclosure may be a television (TV), but embodiments are not limited thereto, and may include a smartphone, a tablet personal computer (PC), a laptop computer, a head mounted display (HMD), a near eye display (NED), a large format display (LFD), a digital signage, a digital information display (DID), a video wall, a projector display, a quantum dot (QD) display panel, quantum dot light-emitting diodes (QLED), micro light-emitting diodes (μLED), a mini LED, and the like various displays, a camera, a camcorder, a printer, a server, etc. Further, the electronic apparatus 100 may include a touch screen with a touch sensor, a flexible display, a rollable display, a three-dimensional (3D) display, a display in which a plurality of display modules are physically connected, etc. Further, the electronic apparatus 100 may include no display or a simple display for indication, etc. like a set-top box (STB), and output an image to a separate external apparatus with a display through a video/audio output port. In addition, the electronic apparatus 100 may include a system itself, in which a cloud computing environment is constructed, but may include any apparatus without limits as long as it can use an artificial intelligence (AI) model to process data.

The content 10 may refer to an image, a moving image, etc. and may include any content that is displayed on the electronic apparatus 100 and causes image-quality degradation in the electronic apparatus 100.

The electronic apparatus 100 may identify the image-quality degradation based on information related to input content 10, a user's pattern of using a display, such as use conditions, a use history, etc. Specifically, the electronic apparatus 100 may use AI technology to identify the image-quality degradation. The AI technology may be achieved by machine learning (deep learning) and technologies related to the machine learning. More detailed descriptions thereof will be provided below.

According to an embodiment, the image-quality degradation is identified using the AI model learned based on a user's use pattern, and thus an obtained result of identifying the image-quality degradation is more reliable.

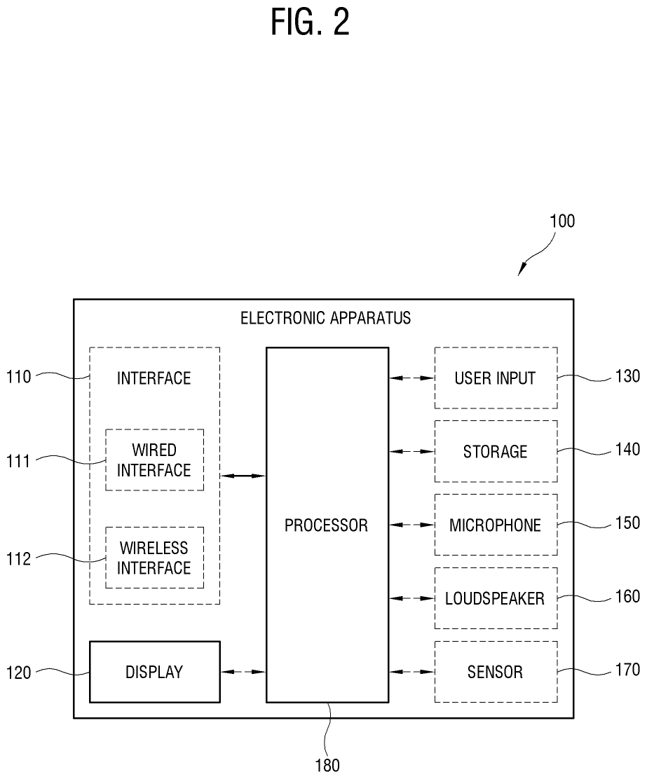

FIG. 2 is a block diagram of an electronic apparatus according to an embodiment.

As shown in FIG. 2, the electronic apparatus 100 may include an interface unit 110.

The interface unit 110 may include a wired interface unit 111. The wired interface unit 111 includes a connector or port to which an antenna for receiving a broadcast signal based on a terrestrial/satellite broadcast or the like broadcast standards is connectable, or a cable for receiving a broadcast signal based on cable broadcast standards is connectable. In addition, the electronic apparatus 100 may include a built-in antenna for receiving a broadcast signal. The wired interface unit 111 may include a connector, a port, etc. based on video and/or audio transmission standards, like an HDMI port, DisplayPort, a DVI port, a thunderbolt, composite video, component video, super video, SCART, etc. The wired interface unit 111 may include a connector, a port, etc. based on universal data transmission standards like a universal serial bus (USB) port, etc. The wired interface unit 111 may include a connector, a port, etc. to which an optical cable based on optical transmission standards is connectable. The wired interface unit 111 may include a connector, a port, etc. to which an external microphone or an external audio device including a microphone is connected, and which receives or inputs an audio signal from the audio device. The wired interface unit 111 may include a connector, a port, etc. to which a headset, an ear phone, an external loudspeaker or the like audio device is connected, and which transmits or outputs an audio signal to the audio device. The wired interface unit 111 may include a connector or a port based on Ethernet or the like network transmission standards. For example, the wired interface unit 111 may be embodied by a local area network (LAN) card or the like connected to a router or a gateway by a wire.

The wired interface unit 111 is connected to a set-top box, an optical media player or the like external apparatus or an external display apparatus, a loudspeaker, a server, etc. by a wire in a manner of one-to-one or one-to-N (where, N is a natural number) through the connector or the port, thereby receiving a video/audio signal from the corresponding external apparatus or transmitting a video/audio signal to the corresponding external apparatus. The wired interface unit 111 may include connectors or ports to individually transmit video/audio signals.

Further, according to an embodiment, the wired interface unit 111 may be embodied as built in the electronic apparatus 100, or may be embodied in the form of a dongle or a module and detachably connected to the connector of the electronic apparatus 100.

The interface unit 110 may include a wireless interface unit 112. The wireless interface unit 112 may be embodied variously corresponding to the types of the electronic apparatus 100. For example, the wireless interface unit 112 may use wireless communication based on radio frequency (RF), Zigbee, Bluetooth, Wi-Fi, ultra wideband (UWB), near field communication (NFC) etc. The wireless interface unit 112 may be embodied by a wireless communication module that performs wireless communication with an access point (AP) based on Wi-Fi, a wireless communication module that performs one-to-one direct wireless communication such as Bluetooth, etc. The wireless interface unit 112 may wirelessly communicate with a server on a network to thereby transmit and receive a data packet to and from the server. The wireless interface unit 112 may include an infrared (IR) transmitter and/or an IR receiver to transmit and/or receive an IR signal based on IR communication standards. The wireless interface unit 112 may receive or input a remote control signal from a remote controller or other external devices, or transmit or output the remote control signal to other external devices through the IR transmitter and/or IR receiver. In addition, the electronic apparatus 100 may transmit and receive the remote control signal to and from the remote controller or other external devices through the wireless interface unit 112 based on Wi-Fi, Bluetooth or the like other standards.

The electronic apparatus 100 may further include a tuner that may tune to a channel of a broadcast signal, when a video/audio signal received through the interface unit 110 is a broadcast signal.

The electronic apparatus 100 may include a display 120 for displaying an image on a screen. The display 120 has a light-receiving structure like a liquid crystal type or a light-emitting structure like an OLED type. The display 120 may include an additional component according to the types of the display 120. For example, when the display 120 is of the liquid crystal type, the display 120 includes a liquid crystal display (LCD) panel, a backlight unit for emitting light, a panel driving substrate for driving the liquid crystal of the LCD panel.

The electronic apparatus 100 may include a user input unit 130. The user input unit 130 includes various kinds of input interface circuits for receiving a user's input. The user input unit 130 may be variously embodied according to the kinds of electronic apparatus 100, and may, for example, include mechanical or electronic buttons of the electronic apparatus 100, a remote controller separated from the electronic apparatus 100, an input unit of an external device connected to the electronic apparatus 100, a touch pad, a touch screen installed in the display 120, etc.

The electronic apparatus 100 may include a storage unit 140. The storing unit 140 is configured to store data. The storing unit 140 includes a nonvolatile storage which retains data regardless of whether power is on or off, and a volatile memory to which data to be processed by the processor 180 is loaded and which retains data only when power is on. The storage includes a flash-memory, a hard-disc drive (HDD), a solid-state drive (SSD) a read only memory (ROM), etc. and the memory includes a buffer, a random access memory (RAM), etc.

The storing unit 140 may be configured to store information about an AI model including a plurality of layers. Here, the information about the AI model may be stored in various pieces based on operations of the AI model, for example, information about the plurality of layers included in the AI model, information about parameters (e.g. a filter coefficient, a bias, etc.) used in the plurality of layers, etc. For example, the storing unit 140 may be configured to store information about an AI model learned to obtain upscaling information of an input image (or information related to voice recognition, information about objects in an image, etc.) according to an embodiment. However, when the processor is embodied by hardware dedicated for the AI model, the information about the AI model may be stored in a built-in memory of the processor.

The electronic apparatus 100 may include a microphone 150. The microphone 150 may receive sound of an external environment such as a user's voice. The microphone 150 may convert an analog signal of the sound to a digital signal and transmit the converted digital signal of the sound to the processor 180. The microphone 150 may receive a user's voice, or receive a voice signal from an external apparatus such as a smartphone, a remote controller with a microphone, etc. through the interface unit 110. The external apparatus may be installed with a remote control application to control the electronic apparatus 100 or perform a function of voice recognition, etc. The external apparatus with such an installed application can receive a user's voice, and perform data transmission/reception and control through Wi-Fi/BT or infrared communication with the electronic apparatus 100, and thus a plurality of interface units 110 for the communication may be present in the electronic apparatus 100.

The electronic apparatus 100 may include a loudspeaker 160. The loudspeaker 160 outputs sound based on audio data processed by the processor 180. The loudspeaker 160 includes a unit loudspeaker provided corresponding to audio data of a certain audio channel, and may include a plurality of unit loudspeakers respectively corresponding to audio data of a plurality of audio channels. Alternatively, the loudspeaker 160 may be provided separately from the electronic apparatus 100, and the electronic apparatus 100 may transmit audio data to the loudspeaker 160 through the interface unit 110.

The electronic apparatus 100 may include a sensor 170. The sensor 170 may detect the state of the electronic apparatus 100 or the surrounding states of the electronic apparatus 100, and transmit the detected state to the processor 180. The sensor 170 may include, but not limited to, at least one of a magnetic sensor, an acceleration sensor, a temperature/moisture sensor, an infrared sensor, a gyroscope sensor a positioning sensor (e.g. a global positioning system (GPS)), a barometer, a proximity sensor, and a red/green/blue (RGB) sensor (e.g. an illuminance sensor). The processor 180 may store a detected value defined by a tap between the electronic apparatus 100 and the external apparatus in the storing unit 140. That is, when a user event is detected, the processor 180 may identify whether the user event occurs or not based on whether the detected value matches the stored value.

The electronic apparatus 100 may include the processor 180. The processor 180 may include one or more hardware processors embodied by a central processing unit (CPU), a chipset, a buffer, a circuit, etc. mounted onto a printed circuit board, and may also be designed as a system on chip (SoC). The processor 180 includes modules corresponding to various processes, such as a demultiplexer, a decoder, a scaler, an audio digital signal processor (DSP), an amplifier, etc. when the electronic apparatus 100 is embodied by a display apparatus. Here, some or all of the modules may be embodied as the SOC. For example, the demultiplexer, the decoder, the scaler, and the like modules related to video processing may be embodied as a video processing SOC, and the audio DSP may be embodied as a chipset separated from the SOC.

The processor 180 for implementing the AI model may be embodied by combination of software and a graphic processing unit (GPU), a vision processing unit (VPU) and the like graphic-dedicated processor, or a neural processing unit (NPU) and the like AI-dedicated processor, as well as an CPU, an application processor (AP), a DSP and the like universal processor. The processor 180 may perform control to process input data, based on the AI model or operation rules previously defined in the storing unit 140. Further, when the processor 180 is an exclusive processor (or a processor dedicated for the AI), the processor 180 may be designed to have a hardware structure specialized for processing a specific AI model. For example, the hardware specialized for processing the specific AI model may be designed as an application specific integrated circuit (ASIC), a field-programmable gate array (FPGA), or the like hardware chip.

The output data may be varied depending on the kinds of AI models. For example, the output data may include, but not limited to, an image improved in resolution, information about an object contained in the image, a text corresponding to a voice, etc.

When a voice signal of a user's voice is obtained through the microphone 150 or the like, the processor 180 may convert the voice signal into voice data. The voice data may be text data obtained through a speech-to-text (STT) process of converting a speech signal into the text data. The processor 180 identifies a command indicated by the voice data, and performs an operation based on the identified command. Both the process of the voice data and the process of identifying and carrying out the command may be performed in the electronic apparatus 100. However, when a system load needed for the electronic apparatus 100 and a required storage capacity are increased, at least a part of the process may be performed by at least one server connected to the electronic apparatus 100 through a network.

The processor 180 may call and execute at least one instruction among instructions for software stored in a storage medium readable by the electronic apparatus 100 or the like machine. This enables the electronic apparatus 100 and the like machine to perform at least one function based on the at least one called instruction. The one or more instructions may include code created by a compiler or code executable by an interpreter. The machine-readable storage medium may be provided in the form of a non-transitory storage medium. Here, the ‘non-transitory’ means that the storage medium is tangible and does not include a signal (for example, an electromagnetic wave), and this term does not distinguish between cases where data is semi-permanently and temporarily stored in the storage medium.

The processor 180 may obtain usage data based on use of the electronic apparatus 100, identify the image-quality degradation of the display 120 according to the obtained usage data and reference data corresponding to a relationship between the use pattern of the electronic apparatus 100 and the image-quality degradation of the display 120, and perform at least part of data analysis, process, and result information generation for preventing the image-quality degradation of the display 120 based on the identification result through at least one of machine learning, a neural network, or a deep learning algorithm as a rule-based or AI algorithm.

An AI system refers to a computer system that has an intelligence similar to a human in which a machine learns and determines by itself, and recognition rates are improved as it is used more.

The AI technology is based on elementary technology by utilizing machine learning (deep learning) technology and machine learning algorithms using an algorithm of autonomously classifying/learning features of input data to copy perception, determination and the like functions of a human brain.

The elementary technology may for example include at least one of linguistic comprehension technology for recognizing a language/text of a human, visual understanding technology for recognizing an object like a human sense of vision, inference/prediction technology for identifying information and logically making inference and prediction, knowledge representation technology for processing experience information of a human into knowledge data, and motion control technology for controlling a vehicle's automatic driving or a robot's motion.

The linguistic comprehension may include recognizing and applying/processing a human's language/character, and includes natural language processing, machine translation, conversation system, question and answer, voice recognition/synthesis, etc. The visual understanding may include recognizing and processing an object like a human vision, and includes object recognition, object tracking, image search, people recognition, scene understanding, place understanding, image enhancement, etc. The inference/prediction may include identifying information and logically making prediction. Specifically, the interface/prediction may include knowledge/possibility-based inference, optimized prediction, preference-based plan, recommendation, etc. The knowledge representation may include automating a human's experience information into knowledge data. Specifically, the knowledge representation may include knowledge building (data creation/classification), knowledge management (data utilization), etc.

For example, the processor 180 may function as both a learner and a recognizer. The learner may perform a function of generating the learned neural network, and the recognizer may perform a function of recognizing (or inferring, predicting, estimating and identifying) the data based on the learned neural network.

The learner may generate or update the neural network. The learner may obtain learning data to generate the neural network. For example, the learner may obtain the learning data from the storage unit 140 or from the outside. The learning data may be data used for learning the neural network, and the data subjected to the foregoing operations may be used as the learning data to make the neural network learn.

Before the neural network learns the learning data, the learner may perform a preprocessing operation with regard to the obtained learning data or select data to be used in learning among a plurality of pieces of the learning data. For example, the learner may process the learning data to have a preset format, apply filtering to the learning data, or process the learning data to be suitable for the learning by adding/removing noise to/from the learning data. The learner may use the preprocessed learning data for generating the neural network which is set to perform the operations.

The learned neural network may include a plurality of neural networks (or layers). The nodes of the plurality of neural networks have weight values, and perform neural network calculation based on the calculation result of the previous layer and the plurality of weight values. The plurality of neural networks may be connected to one another so that an output value of a certain neural network can be used as an input value of another neural network. As an example of the neural network, there are a convolutional neural network (CNN), a deep neural network (DNN), a recurrent neural network (RNN), a restricted Boltzmann machine (RBM), a deep belief network (DBN), a bidirectional recurrent deep neural network (BRDNN) and deep Q-networks.

For example, the recognizer may obtain target data to carry out the foregoing operations. The target data may be obtained from the storage unit 140 or from the outside. The target data may be data targeted to be recognized by the neural network. Before applying the target data to the learned neural network, the recognizer may perform a preprocessing operation with respect to the obtained target data, or select data to be used in recognition among a plurality of pieces of target data. For example, the recognizer may process the target data to have a preset format, apply filtering to the target data, or process the target data into data suitable for recognition by adding/removing noise. The recognizer may obtain an output value output from the neural network by applying the preprocessed target data to the neural network. Further, the recognizer may obtain a stochastic value or a reliability value together with the output value.

The learning and training data for the AI model may be created through an external server. However, embodiments are not limited thereto, and the learning of the AI model may be performed in the electronic apparatus, and the learning data may be also created in the electronic apparatus.

For example, the method of controlling the electronic apparatus 100 according an embodiment may be provided in a computer program product. The computer program product may include instructions of software to be executed by the processor 180 as described above. The computer program product may be traded as a commodity between a seller and a buyer. The computer program product may be distributed in the form of a machine-readable storage medium (for example, a compact disc read only memory (CD-ROM)) or may be directly or online distributed (for example, downloaded or uploaded) between two user apparatuses (for example, smartphones) through an application store (for example, Play Store™). In the case of the online distribution, at least a part of the computer program product may be transitorily stored or temporarily produced in a machine-readable storage medium such as a memory of a manufacturer server, an application-store server, or a relay server.

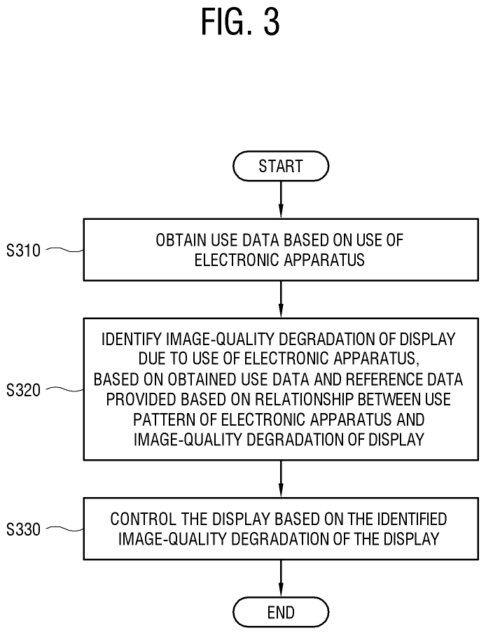

FIG. 3 is an operation flowchart of an electronic apparatus according to an embodiment.

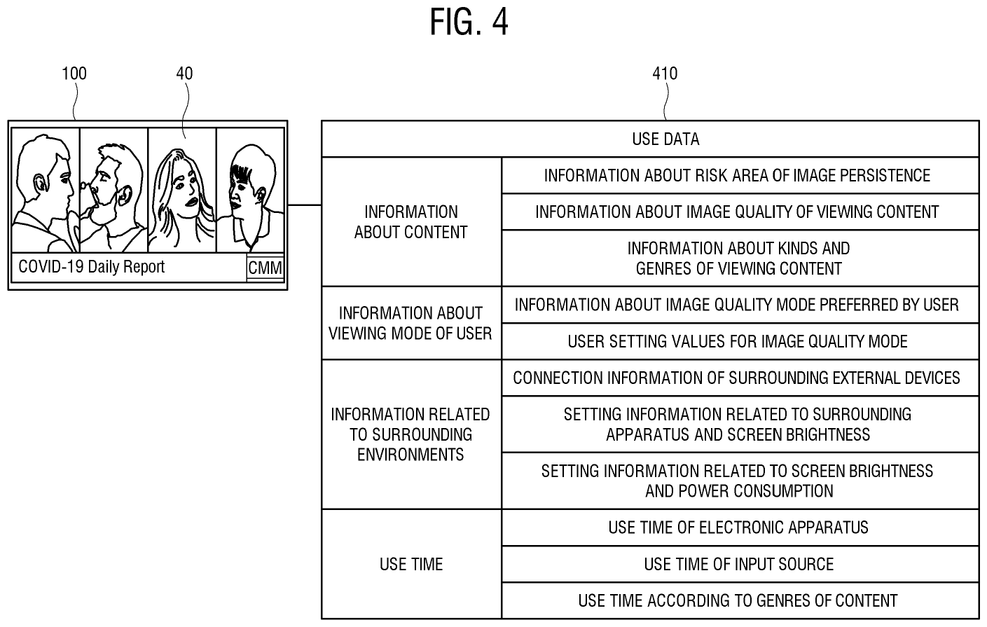

The processor 180 may obtain usage data 410 (shown in FIG. 4) based on use of the electronic apparatus 100 (S310). The usage data 410 obtained by the processor 180 may include not only image information of the content, but also data detected by the electronic apparatus 100. The usage data 410 may include, but not limited to, user information, information about a user preferred image-quality mode, setting values, a user's use time corresponding to content genres, information related to surrounding environments, input-source use time, use time according to cycles of the electronic apparatus 100, etc. Details of the usage data will be described later with reference to FIG. 4.

The processor 180 may identify the image-quality degradation of the display 120 according to the use of the electronic apparatus 100, based on the obtained usage data 410 and the reference data corresponding to a relationship between the use pattern of the electronic apparatus 100 and the image-quality degradation of the display 120 (S320).

According to an embodiment, the reference data may be provided based on the relationship between the use pattern of the electronic apparatus 100 and the image-quality degradation of the display 120. The use pattern of the electronic apparatus 100 may be derived from certain data corresponding to the foregoing usage data 410. For example, it is assumed that information about content in certain data includes information that a user prefers a news channel, and views the news channel for about three hours in a daily basis. In this case, various pieces of information related to a position of a broadcasting station logo of the corresponding news channel, a position of a headline, a position of an announcer, distribution of them, cycles, etc. may be included in the use pattern of the electronic apparatus 100.

The reference data may be used to train a model to perform operations related to identification for the image-quality degradation of the display 121 based on the use of the electronic apparatus 100. That is, with data obtained under certain conditions, the reference data showing the relationship between the use pattern and the image-quality degradation may be obtained based on a plurality of categorized use patterns of the electronic apparatus 100 and the image-quality degradation of the display 120 caused by the use patterns.

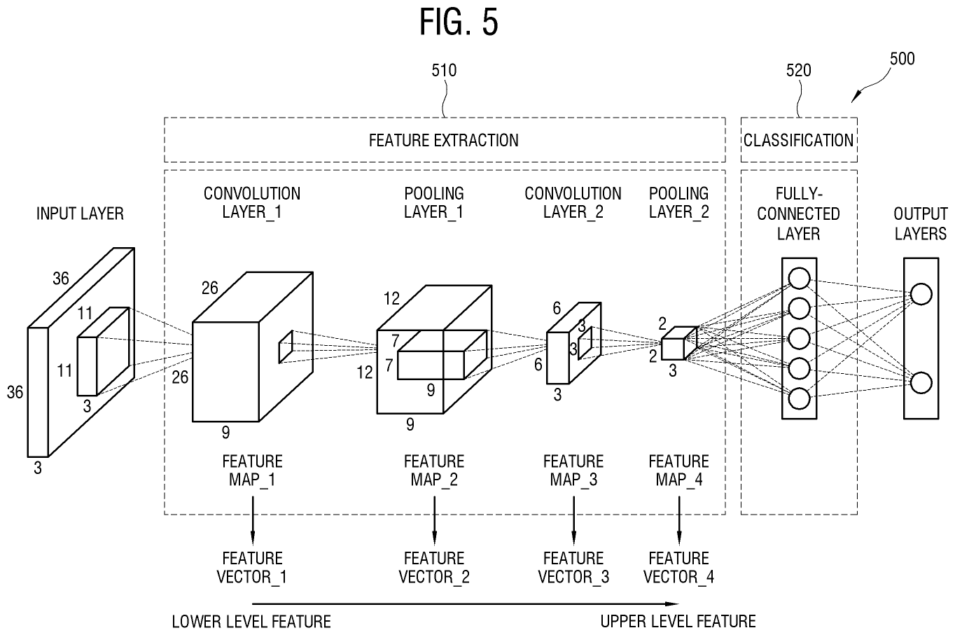

According to an embodiment, as shown in FIG. 5, the model may be learned using a CNN 500 as one of the foregoing neural networks. Details descriptions of the CNN 500 will be described below. The image-quality degradation may be affected not only by the current states or conditions of the display, but also by the previous states or conditions of the display, and thus a neural network using convolutions for taking both the current and previous states or conditions into account may be used.

Specifically, the processor 180 may identify whether image-quality degradation occurs corresponding to the usage data 410, based on the model that learns data about the image-quality degradation of the display 120 according to the use pattern of the electronic apparatus 100.

The processor 180 may control the display 120 based on the identified image-quality degradation of the display (S330). The processor 180 may perform an operation for preventing the image-quality degradation of the display 120 based on an identification result.

When the image-quality degradation is identified, the processor 180 may decrease a stress level by lowering the whole brightness of the display 120, deconcentrate the display 120 by shifting a pixel, or use the like method to prevent the image-quality degradation. Further, the processor 180 may perform calibration for readjusting the color temperature, brightness, contrast, etc. of the display 120. For example, when such a method is used, the processor 180 may obtain the use patterns of the content being currently viewed by a user, a user's preferred viewing mode, etc., and change the settings based on the obtained use patterns.

According to an embodiment, the reference data may be used to detect the risk of the image persistence, thereby reducing costs and complexity, and flexibly and effectively coping with an image persistence phenomenon.

According to an embodiment, the risk of image persistence is detectable based on a relationship between a user's pattern of using an electronic apparatus and image-quality degradation of a display, and thus the image-quality degradation is more reliably identifiable, thereby providing more economical and effective way of preventing the image-quality degradation.

FIG. 4 illustrates usage data obtained according to an embodiment.

The processor 180 may obtain information about content viewed by a user, for example, (1) information about a previously defined area where risk of image persistence is high in content, for example, the size, position, display time, distribution, etc. of a broadcaster logo or the like, (2) information about image quality of viewing content, for example, high dynamic range (HDR), standard dynamic range (SDR), etc., (3) information about the kinds of content such as a movie, a soap opera, news, etc., (4) information about genres of content such as comedy, drama, horror, action in a case of the movie among pieces of the viewing content, and (5) time taken in viewing pieces of content, etc. The image quality of the content may not be the image quality of the content itself, but the image quality of the content displayed on the display 120. For example, when the content is produced to have SDR image quality, but output as HDR by the processor 180, the HDR image quality is actually displayed on the display 120 and thus reflected in identifying the image-quality degradation. Further, when preset modes in the electronic apparatus 100 and corresponding setting values, for example, a dynamic mode, a standard mode, a natural mode, a movie mode, a game mode or a mode set by a user manually, it is possible to obtain information about an image quality mode preferred by a user and corresponding setting values among the modes and the setting values. Further, when information is related to surrounding environments, for example, when the electronic apparatus 100 interworks with a surrounding lighting device, the processor 180 may obtain information about the brightness of the interworking device and settings related to corresponding power consumption. In addition, the processor 180 may obtain information about a use time of the electronic apparatus 100 at a predetermined interval. For example, the information about the user time of the electronic apparatus 100 may be measured every three hours, or when the electronic apparatus 100 is used at least four times in one hour. The information obtained as the usage data 410 is not limited to this embodiment, but may include any information which can affect the image-quality degradation of the display 120.

As shown in FIG. 4, when content 40 viewed by a user relates to news, the processor 180 may obtain information about the size, position, display time, distribution, etc. of a broadcaster logo, a headline, etc., of which risk of image persistence is high. In addition, the processor 180 may obtain information about the image quality of the news, and a time duration for which the news is viewed, as the usage data 410. Further, the mode for viewing the news and the corresponding setting values, for example, the brightness of the interworking device and the settings related to the corresponding power consumption when the electronic apparatus 100 interworks with the surrounding lighting device may be obtained. Also, the processor 180 may obtain information about measured use time of the electronic apparatus 100.

According to an embodiment, it is possible to identify the actual image-quality degradation of the display 120 based on comparison between a user's use pattern and reference data prepared based on the relationship between the use pattern of the electronic apparatus 100 and the image-quality degradation of the display 120, thereby more accurately identifying the image-quality degradation.

FIG. 5 illustrates an example of a CNN structure used by an electronic apparatus according to an embodiment. A CNN 500 shown in FIG. 5 may be used in training a model as mentioned above in the operation S320 of FIG. 3. The CNN 500 includes a convolution feature extraction module 510 and a classification module 520. The convolution feature extraction module 510 extracts features from input data, and the classification module 520 uses the neural network to perform classification based on the extracted features. According to an embodiment, the input data may include the foregoing usage data 410 or other data.

A convolution layer, which serves to extract the features from the input data, may include a filter for extracting the features, and an activation function for changing a value of the filter into a nonlinear value. The filter may refer to a function that detects whether features of content to be extracted are present in target data. When a feature map is extracted through the filters, a value is activated by applying the activation function, for example, sigmoid and rectified linear unit (reLU) functions to the feature map. Such extracted features are subjected to sub-sampling as necessary, and this is to decrease operation quantity by reducing the size of the extracted feature map, which is also called ‘pooling.’

The feature extraction module 510 may extract one or more feature maps, i.e., a feature map_1 to a feature map_4, which are generated in a CNN structure, and use the extracted feature map as the feature of the input data. The feature extraction module 510 may convert such feature maps, the feature map_1 to the feature map_4 into vectors, and output at least one of feature vectors (e.g., a feature vector_1 to a feature vector_4).

The feature extraction module 510 may use the convolution layer and various filters to extract various features in various scales of an image. Usually, the shallower the convolution layer, the lower the level of the features extracted from the input data, and the deeper the convolution layer, the higher the level of the features extracted from the input data. Therefore, the feature extraction module 510 may properly extract and use a feature map corresponding to an upper level feature, and a feature map corresponding to a lower level feature.

Further, a factor of features to be extracted from the input data may be adjusted based on the filter or the like used in each convolution layer. For example, a filter used in extracting content information from the input data or a filter used in extracting information about a use environment from the input data may be used to extract content features or use environment features from the input data.

When the features are extracted from the convolution layer, a fully connected layer of the classification module 520 may perform the classification by applying such extracted features to the neural network. For example, the softmax function may be used.

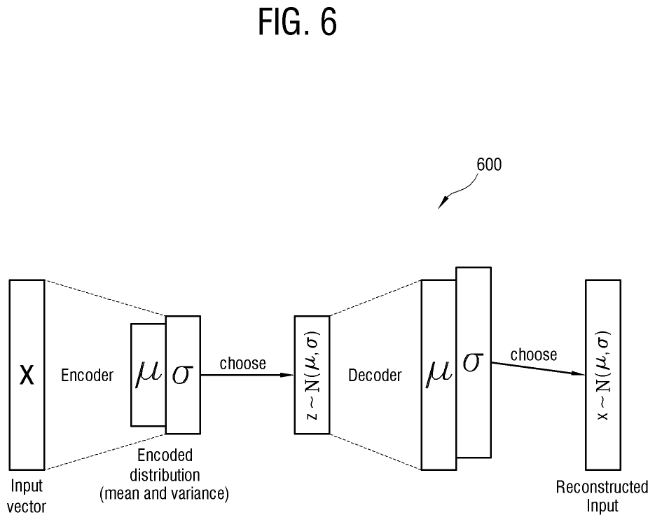

FIG. 6 illustrates an operation of an electronic apparatus according to an embodiment. FIG. 6 shows a structure 600 of an encoder and a decoder. This structure is to find a latent variable Z on the assumption that the latent variable Z affecting certain data X is present. According to an embodiment, the data X may be the usage data 410, and the latent variable Z may be a factor extracted from the usage data 410 and causing the image-quality degradation of the display 120. For example, when the CNN 500 described in FIG. 5 or the like environment adaptive model is applied, the encoder and decoder structure may be configured with a serial in which the convolution layer is contracted from a deep dimension to a shallow dimension in the encoder but expanded again from the shallow dimension to the deep dimension in the decoder. As such, an input layer of the encoder and an output layer of the decoder may have the same number of nodes in the encoder and decoder structure. However, embodiments are not limited thereto, and the number of nodes may be variously configured without limitations.

The reference data may, as described above, be a model learned to perform an operation for identifying the image-quality degradation of the display 120 according to use of the electronic apparatus 100. Here, it may be assumed that the reference data according to an embodiment is learned through the encoder and decoder structure to which the CNN model is applied based on an input of data about a plurality of categorized use patterns of the electronic apparatus 100. The use pattern may be arbitrarily designed or previously defined. The encoder is learned using an input of data about all the use patterns, and the decoder is learned to output data about the preset degradation by regarding the output of the encoder as an input. Below, the operations of the processor 180 will be described based on the reference data prepared by the foregoing method.

The processor 180 may vectorize the obtained usage data 410, compress the dimension of the vectorized usage data 410, and identify whether the image-quality degradation of the display 120 occurs due to the use of the electronic apparatus 100. The compression of the dimension of the usage data 410 may mean a process of identifying the usage data 410 for which a relationship between the usage data 410 and the image-quality degradation is valid. That is, the processor 180 may be configured to validate the usage data 410 that corresponds to one from among the plurality of categorized patterns of using the electronic apparatus 100. The structure of the encoder employing the CNN model according to an embodiment is effective because the valid usage data is identifiable while a huge amount of certain data is decreased in dimension.

Further, the processor 180 may identify the image-quality degradation of the display 120, while expanding the dimension of the compressed usage data 410 again through the decoder. In this case, the re-expansion of the dimension of the compressed usage data 410 may, for example, mean that the processor 180 combines the valid usage data 410 identified through the encoder. Therefore, the relationship with the image-quality degradation of the display 120 may be identified based on the combined usage data 410.

When the foregoing encoder and decoder structure is applied to the usage data 410, a result may be obtained as follows. For example, it may be assumed that the usage data 410 includes a dynamic mode of a user preferred image-quality mode, setting values of the dynamic mode, a user's view history for three days (Monday—4 hours, Tuesday—2 hours, and Wednesday—5 hours), view timeslots (Monday: 6 PM-7:30 PM, 8:30 PM-10 PM, and 11-12 PM, Tuesday: 7 AM-9 AM, and Wednesday: 6 PM-11 PM), the kinds of viewed content (Monday—news, Tuesday—drama, and Wednesday—news), and information about viewed news and drama channels. In a case of a news channel viewed by a user, the reference data includes information about a position of a headline, a position of a broadcaster logo, a sending time of an anchor, and a sending time of a data screen when a corresponding broadcaster broadcasts a news, a relationship with image-quality degradation of when a viewing cycle is continuous and discontinuous, etc. When the foregoing usage data 410 is input to the encoder, the processor 180 may output data having a dimension reduced to show a use pattern of a user in the usage data 410, and output a result of the image-quality degradation that occurs at the use pattern corresponding to the user's use pattern in the decoder. Therefore, an obtained result may be that the image-quality degradation occurs when a user views news in the dynamic mode or when a user continuously views news for more than three hours.

When the encoder and decoder structure is used, it is advantageous that data having a desired size is obtainable while reducing and expanding the dimension of the data. However, the structure described above is not limited thereto.

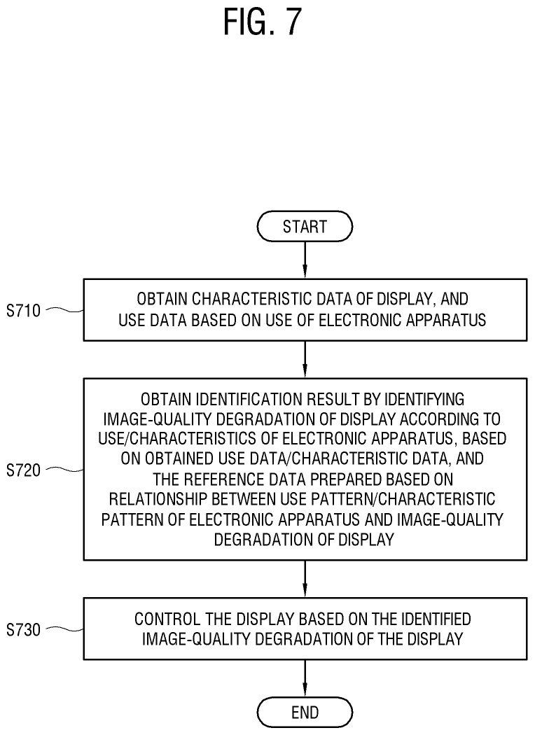

FIG. 7 is an operation flowchart of an electronic apparatus according to an embodiment. Regarding this drawing, repetitive descriptions of those in FIGS. 3 to 6 will be omitted.

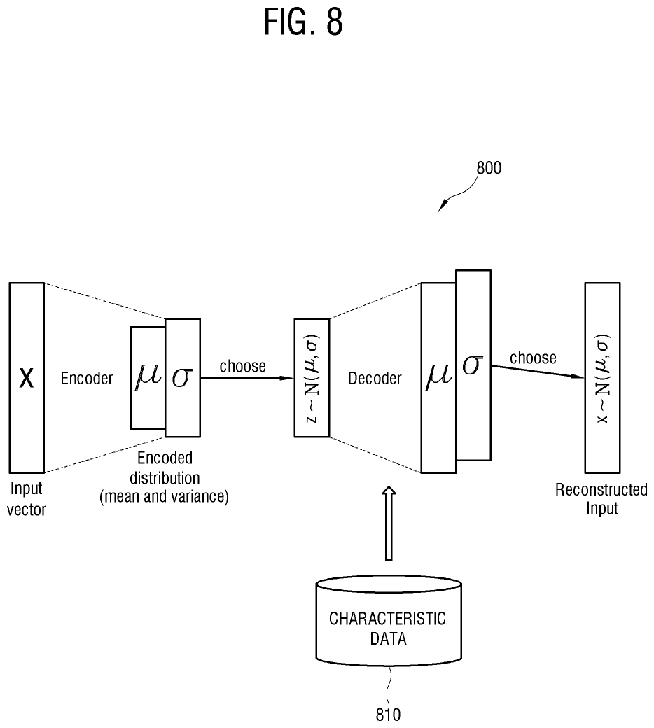

According to an embodiment, the processor 180 may obtain characteristic data (see ‘810’ in FIG. 8) of the display 120 in addition to the usage data 410 based on the use of the electronic apparatus 100 (S710). The characteristic data 810 of the display 120 refers to information according to manufacturers and products of the display 120, and more particularly, may include data such as uniformity of brightness, brightness, actual luminescent quantities according to R/G/B/W colors, heat-emission quantity, a stress level, a circuit layout behind a panel, etc.

According to an embodiment, the characteristic data 810 may be obtained by measuring optical characteristics of the display 120 by a specific pattern. The characteristic data 810 may be measured based on a value obtained by sampling a certain area of the display 120, or sampling a plurality of areas divided from the display 120, and the characteristic data 810 is not limited to any one of the characteristics.

According to an embodiment, the processor 180 may store optimal initial setting values in advance in the storage unit 140 with regard to the characteristic data 810, or receive and reflect the characteristic data 810 from a server or the like external apparatus through the interface unit 110, in which the characteristic data 810 is not limited to any one of the characteristics.

The processor 180 may obtain an identification result by identifying whether the image-quality degradation occurs in the display according to use/characteristics of the electronic apparatus 100, based on the obtained usage data 410/characteristic data 810, and the reference data prepared based on a relationship between the use pattern/characteristic pattern of the electronic apparatus 100 and the image-quality degradation of the display (S720).

According to an embodiment, the reference data may be provided based not only on the use pattern of the electronic apparatus 100, but also based on a relationship between the characteristic pattern and the image-quality degradation of the display 120. The characteristic pattern of the display 121 may be derived from certain data corresponding to the foregoing characteristic data 810. For example, as information about the display 120 in certain data, the characteristic pattern of the display 120 may include R luminescent quantity in a specific area of the display 121, or a position itself of a circuit generating heat on the rear of the display 121. In this case, the reference data may be a model learned to perform an operation related to identification for the image-quality degradation of the display 120 according to the characteristics of the display 120. Therefore, with data obtained under many conditions, the reference data showing the relationship between the characteristic pattern and the image-quality degradation may be prepared based on a plurality of categorized characteristic patterns of the electronic apparatus 100 and the image-quality degradation of the display 120 caused by the characteristic patterns.

According to an embodiment, as shown in FIG. 5, the model may be learned using the CNN 500 as one of the foregoing neural networks, like the use pattern of the electronic apparatus 100.

Therefore, the processor 180 uses a model learned about whether the image-quality degradation of the display 120 occurs by taking both the use pattern of the electronic apparatus 100 and the characteristic pattern of the display 121, thereby identifying whether the image-quality degradation occurs when a user's actual usage data 410 and the characteristic data 810 of the corresponding display 120 are input.

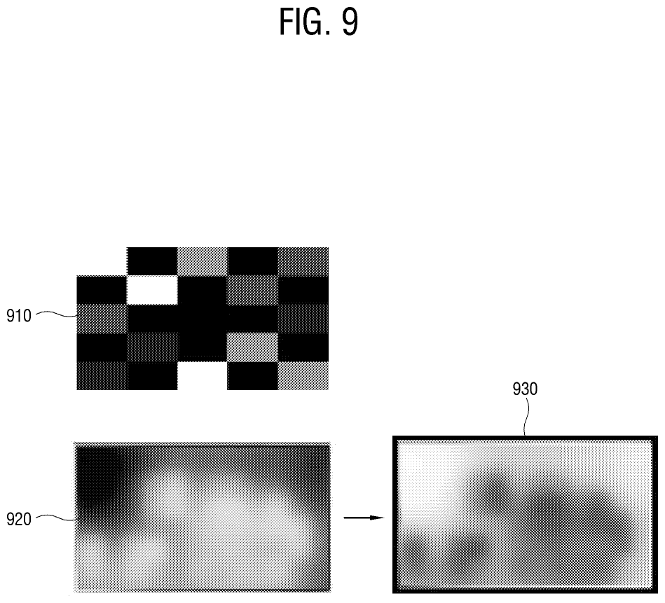

The processor 180 may be configured to control the display 120 based on the identified image-quality degradation of the display (S730). The processor 180 may perform an operation of preventing the image-quality degradation of the display based on the identification result. According to an embodiment, the processor 180 may identify whether the image-quality degradation of the display 121 occurs based on use of the electronic apparatus 100 according to screen areas of the display 121. More detailed descriptions will be made later with reference to FIGS. 8 to 9.

According to an embodiment, the usage data and the characteristic data of the display may be taken into account, thereby more accurately identifying the image-quality degradation of the display.

FIG. 8 illustrates an operation of an electronic apparatus according to an embodiment. FIG. 8 shows an encoder and decoder structure 800 of which an operation principle is the same as described with reference to FIG. 6.

As described above, the processor 180 may vectorize the obtained usage data 410, and the encoder compresses the dimension of the vectorized usage data 410, thereby identifying a factor causing the image-quality degradation of the display 120 based on the use of the electronic apparatus 100. The processor 180 may identify the image-quality degradation of the display 120 by using the characteristic data 810 of the electronic apparatus 100 while expanding the compressed dimension of the usage data 410 again through the decoder. For example, the processor 180 may identify the image-quality degradation of the display 120 by expanding the compressed dimension of the usage data to correspond to the screen area of the display 120 based on the characteristic data 810 of the display 120.

According to an embodiment, based on a user's use pattern derived from the usage data 410, if it is identified which factors affect the image-quality degradation of the display 120 and it is thus identified whether the image-quality degradation occurs due to the identified factors, it is possible to identify which actual areas of the display 120 and how far the image-quality degradation occurs, through the characteristic data 410 based on the foregoing identifications. In this case, the processor 180 may divide the display 120 into a plurality of areas and mark an area where the image-quality degradation Occurs, or may calculate the risk of the image-quality degradation in the form of a heat map based on a resolution as shown in FIG. 9.

Further, the processor 180 may use the calculated heat map to perform operations for preventing the image-quality degradation, such as predicting the life of the area where the risk of the image persistence is high, managing the image quality, and managing the power consumption.

FIG. 9 illustrates an operation of an electronic apparatus according to an embodiment. The processor 180 may identify the image-quality degradation of the display 120 based on use of the electronic apparatus 100 according to a screen 910 or the like screen areas of the display 120.

FIG. 9 shows that the characteristic data 810 of the display 120 is reflected to calculate a reflection result into a heat map when the processor 180 uses the encoder and decoder structure 800 of FIG. 8.

According to an embodiment, the processor 180 may identify the image-quality degradation of the display 120 by expanding the dimension of the usage data 410 compressed through the encoder to correspond to the screen area of the display 121 based on the characteristic data 810 of the display 120. Further, the processor 180 may output a result of identifying the image-quality degradation based on a screen 920 having the same resolution as the display 120. Such an output result as the screen 920 will be called the heat map.

In this case, to calculate a result, not only the usage data 410 including the attributes and the like of the content being output but also the characteristic data 810 including the hardware configurations of the display 120 being actually output may be used together.

For example, in addition to the foregoing result (the image-quality degradation may occur when a user views news in the dynamic mode or continuously views news for more than three hours, etc.) according to the embodiment described above with reference to FIG. 6, an output result may be that the image-quality degradation occurs in particular areas of the display 120. For example, the image-quality degradation may occur in areas corresponding to a news headline portion, a position of an anchor, etc. Because a panel temperature or the like based on how far content is reproduced may affect the image-quality degradation, the characteristic data 810 may also be reflected in calculating the result. Such effects of hardware configuration on the image-quality degradation may be reflected by receiving separate feedback on the measured temperature or the like of the display 120, or using information which is received from the outside or previously stored and in which a relationship between the display 120 and temperature is set according to manufacturers.

The processor 180 may performs a compensation process for a screen 920, to which a result of identifying the image-quality degradation is output, with a screen 930, thereby preventing the image-quality degradation.

In a case of the compensation process, the processor 180 may perform the compensation process based on reverse compensation data of the image-quality degradation shown in the heat map, for example, backlight dimming for adjusting the brightness of a backlight, etc.

The processor 180 may obtain the usage data and the characteristic data according to areas in real time or periodically, and identify the image-quality degradation based on the collected data or update the collected data.

The processor 180 may control the display 120 to display a graphic user interface (GUI), which guides the screen of the electronic apparatus 100 to be photographed under a specific photographing environment, for example, under a darkroom or the like environment, compare a predicted image-quality degradation degree and an actual image-quality degradation degree based on the displayed GUI, and synchronize the predicted degradation degree with the actual image-quality degradation degree by using the concept of visibility compensation.

According to an embodiment, the image-quality degradation of the display is displayed in more detail, and therefore the compensation process for the degradation is also more accurately performed, thereby having an effect on preventing the image-quality degradation.

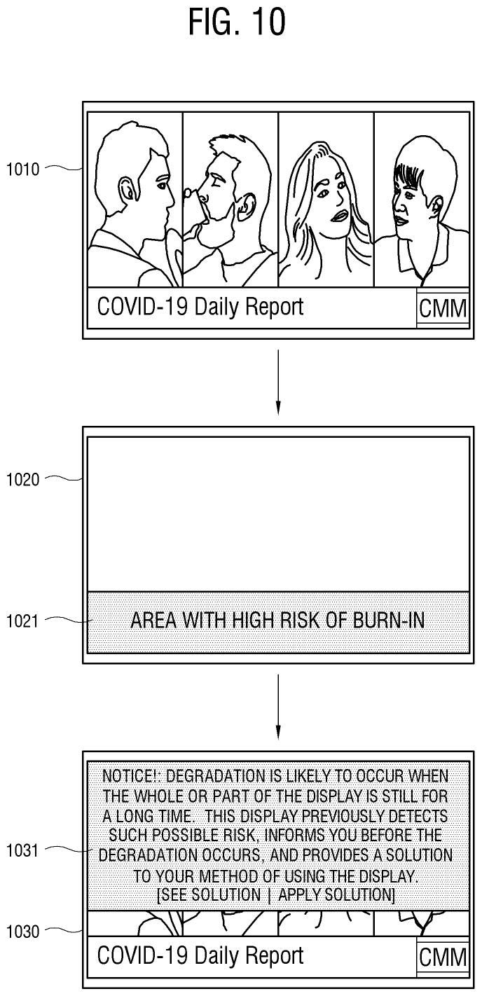

FIG. 10 illustrates an operation of an electronic apparatus according to an embodiment. It will be assumed that the processor 180 identifies a certain area 1021 of a screen 1020 as a region where risk of image-quality degradation is high, when a screen 1010 or the like content is displayed on the display 120, as a result of operation according to the disclosure through a model technique described above based on the obtained usage data and characteristic data.

The processor 180 may control the display 120 to display a GUI 1031, which includes a result of identifying the image-quality degradation on a screen 1030 of the display 120. Here, the GUI 1031 may be displayed in the form of OSD as shown in FIG. 10, and the processor 180 may display the OSD to overlap with a position where the risk of the image-quality degradation is high, or change the form (e.g., the size, brightness, etc.) of the OSD to have features for removing the image-quality degradation. Further, when the risk of the image persistence is displayed through the OSD, a specific color patch may be added to the corresponding area to provide information about a current image-quality degradation level in various forms so that a user can recognize the image-quality degradation of the display 121.

As an example of the GUI 1031, a user may be provided with a guide about a plurality of operations for preventing image-quality degradation or a guide to directly apply a proper operation to the electronic apparatus 100 with “[see solution|apply solution]” together with a guide message of “Notice!: Degradation is likely to occur when the whole or part of the display is still for a long time. This display previously detects such possible risk, informs you before the degradation occurs, and provides a solution to your method of using the display.”

According to another embodiment, the processor 180 may display a GUI that directly provides a guide about a solution for preventing the image-quality degradation of the display 120, and allow a user to select whether to apply the solution.

Therefore, the processor 180 may receive a user input of determining whether to perform the operation for preventing the image-quality degradation of the display 120, through the GUI 1031.

The processor 180 may perform the operation for preventing the image-quality degradation based on a received user input. When the operation for preventing the image-quality degradation is not performed based on the received user input, a GUI for warning a user about the image-quality degradation of the display 120 may be additionally displayed.

According to an embodiment, a user may recognize the risk of the image-quality degradation through the GUI, and receive a corresponding solution, thereby easily and conveniently preventing the display from the image-quality degradation before the image-quality degradation.

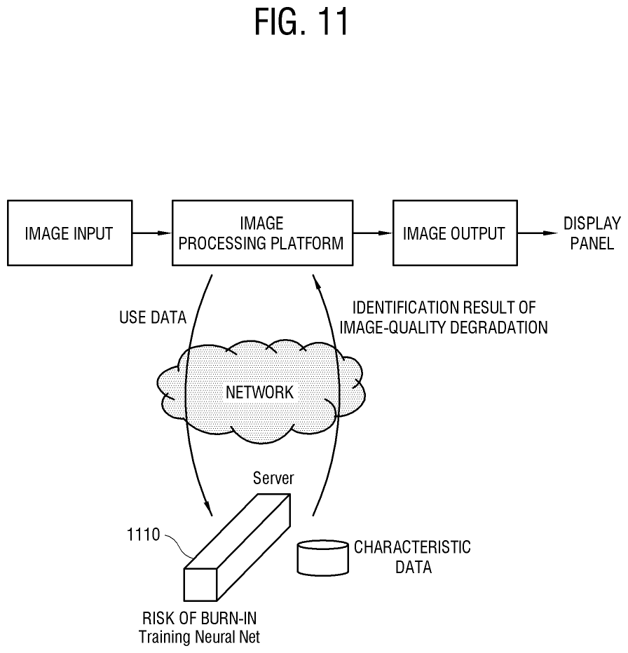

FIG. 11 illustrates an operation of an electronic apparatus according to an embodiment.

In the embodiments as described above, the processor 180 of the electronic apparatus 100 autonomously identifies whether the image-quality degradation occurs. In terms of realization, the method by which the electronic apparatus 100 autonomously identifies the image-quality degradation is implemented to have an effectively reduced learning model rather than a method using a network.

However, according to this embodiment, the electronic apparatus 100 may not only autonomously identify whether the image-quality degradation occurs, but also receive an identification result from a server 1110. That is, the processor 180 may obtain usage data, and transmit the obtained usage data to the server 1110 through the interface unit 110. When the server 1110 identifies the image-quality degradation of the display 120 due to certain usage of the electronic apparatus 100 based on the received usage data and the reference data, the processor 180 may receive the identification result from the server 1110 through the interface unit 110. Here, the amount of data that the server 1110 can accommodate is larger than that of the electronic apparatus 100 autonomously performing the operation, thereby more accurately generating a model when the model is generated based on the AI.

In addition, when the network connection is established, a learning model of the electronic apparatus 100 may be used as a pre-trained model, and the server 1110 or the like may perform deep learning based on this model, thereby allowing both the electronic apparatus 100 and the server 1110 to do simultaneous learning.

According to an embodiment, the server connected to the network may operate regardless of the amount of data unlike the electronic apparatus's own operation, thereby improving operation speed or accuracy.

Although some embodiments of the disclosure have been illustrated and described, the disclosure is not limited to these embodiments, and various modifications can be made by a person having an ordinary skill in the art without departing from the scope of the disclosure, and such modifications should be construed as falling within the technical concept or prospect of the disclosure.

What is claimed is:

1. An electronic apparatus comprising:
a display; and
a processor configured to:
obtain usage data based on use of the electronic apparatus,
identify image-quality degradation of the display based on the usage data and reference data obtained based on a relationship between a use pattern of the electronic apparatus and the image-quality degradation of the display, and
control the display based on the identified image-quality degradation of the display.

2. The electronic apparatus of claim 1, wherein the processor is further configured to:
identify the image-quality degradation of the display based on a relationship between characteristic data of the display and the image-quality degradation of the display.

3. The electronic apparatus of claim 2, wherein the processor is further configured to:
vectorize the usage data, and
identify the image-quality degradation of the display by compressing a dimension of the vectorized usage data.

4. The electronic apparatus of claim 2, wherein the processor is further configured to identify the image-quality degradation of the display according to screen areas of the display.

5. The electronic apparatus of claim 3, wherein the processor is further configured to identify the image-quality degradation of the display by expanding the compressed dimension of the vectorized usage data to correspond to screen areas of the display, based on the characteristic data of the display.

6. The electronic apparatus of claim 1, wherein the processor is further configured to periodically identify the image-quality degradation of the display.

7. The electronic apparatus of claim 1, wherein the reference data comprises a model learned to identify the image-quality degradation of the display based on the use of the electronic apparatus.

8. The electronic apparatus of claim 1, further comprising an interface,
wherein the processor is further configured to:
transmit the usage data to a server through the interface, and
receive a result of identifying the image-quality degradation of the display from the server.

9. The electronic apparatus of claim 1, wherein the processor is further configured to display a graphic user interface (GUI) comprising a result of the identification on the display.

10. The electronic apparatus of claim 9, wherein the processor is further configured to receive a user input indicating whether to control the display based on the identified image-quality degradation of the display, through the GUI.

11. A method of controlling an electronic apparatus, comprising:
obtaining usage data based on use of the electronic apparatus;
identifying image-quality degradation of a display based on the usage data and reference data obtained based on a relationship between a use pattern of the electronic apparatus and the image-quality degradation of the display; and
control the display based on the identified image-quality degradation of the display.

12. The method of claim 11, wherein the identifying the image-quality degradation of the display further comprises:
identifying the image-quality degradation of the display based on a relationship between characteristic data of the display and the image-quality degradation of the display.

13. The method of claim 12, wherein the identifying the image-quality degradation of the display further comprises:
vectorizing the usage data; and
identifying the image-quality degradation of the display by compressing a dimension of the vectorized usage data.

14. The method of claim 12, wherein the identifying the image-quality degradation of the display further comprises: identifying the image-quality degradation of the display according to screen areas of the display.

15. The method of claim 13, wherein the identifying the image-quality degradation of the display further comprises: identifying the image-quality degradation of the display by expanding the compressed dimension of the vectorized usage data to correspond to screen areas of the display, based on the characteristic data of the display.
